(19) United States
(12) Patent Application Publication
(10) Pub. No.: US 2024/0295576 A1
(43) Pub. Date: Sep. 5, 2024

(54) AN IMPROVED INTERFACE FOR THE CONTROLLED TRANSPORT OF A SOLUTION OR SUSPENSION MIXTURE TOWARD A TARGET ZONE

(71) Applicant: SPECTRA ANALYSIS INSTRUMENTS, INC., Marlborough, MA (US)

(72) Inventors: William W. CARSON, Hopkinton, MA (US); Ross C. WILLOUGHBY, Pittsburgh, PA (US)

(73) Assignee: SPECTRA ANALYSIS INSTRUMENTS, INC., Marlborough, MA (US)

(21) Appl. No.: 18/275,711

(22) PCT Filed: Feb. 10, 2022
(86) PCT No.: PCT/IB2022/051190

§ 371 Date: Aug. 3, 2023

(30) Foreign Application Priority Data
Feb. 11, 2021 (IT) 102021000003053

(51) Int. Cl. G01N 35/10

(52) U.S. Cl. CPC G01N 35/1009

(57) ABSTRACT

Interface (350) for the controlled transport of a flow of an inlet mixture (352), in solution or suspension, towards a target zone, preferably towards a deposition surface (610), characterized in that it comprises:—a perforated extraction barrier (402) comprising at least one laminar element perforated with a plurality of holes intended to be crossed by a flow of said mixture (352), said perforated extraction barrier (402) being positioned at the entrance of a compression region (560) configured to reduce the cross section of said flow (352),—said compression region (560) being fluidically connected with at least one opening for the inlet of a gas counterflow (606),—said compression region (560) being fluidically connected with an exhaust circuit (508) for at least one gas, said exhaust circuit (508) being positioned between the perforated extraction barrier (402) and the opening for the inlet of said gas counterflow (606).

### TECHNICAL FIELD

The present invention relates to an improved interface for the controlled transport of an input solution or suspension mixture toward a target zone. Such interface comprises:
a perforated extraction barrier comprising a plurality of holes intended to be crossed by a stream of said mixture, said perforated extraction barrier being positioned at the entry of a compression region configured for reducing the cross-section of the stream,
said compression region being fluidically connected with an opening for the entry of a gas counterflow,
said compression region being fluidically connected with an exhaust circuit that is positioned between the perforated extraction barrier and the opening for the entry of a gas counterflow.

Such interface may be part of a method and apparatus for desolvating and/or concentrating flowing liquid streams while retaining temporal resolution of dissolved solutes. This apparatus utilizes a small-scale self-regulating spray dryer that preserves temporal resolution while desolvating and/or concentrating, i.e. increasing the concentration of the solute in the eluent itself, a liquid chromatography eluent stream and depositing the solute onto an optical surface for infrared spectrographic analysis or other surface analysis or deposition techniques. The liquid eluent is pumped through a heated nebulizer to create a charged aerosol comprising solute containing liquid droplets and solvent vapor. The aerosol is directed circumferentially inside a heated toroidal chamber. Centrifugal force causes the larger liquid droplets to travel along the outer diameter of the chamber. The chamber surface is heated to a temperature sufficient to cause the droplets to film boil. Film boiling reduces the droplet contact with the chamber surface, thereby retaining the solute in the droplets. The solute temperature is limited by evaporative cooling of the droplets. When the electrically charged droplets containing solute particles are sufficiently small, stokes drag from the evaporated solvent gas carries the solute particles toward the center of the chamber.

The interface according to the invention is positioned at the exit of an evaporation chamber and is configured so that the electrically charged solute particles are separated from the solvent vapor by a repeller electrode that serves to repel the electrically charged particles from the solvent vapor exhaust path of a further exhaust circuit that is fluidically connected with the entry region of the interface.

The flow of solvent vapor through the exhaust path of the further exhaust circuit, and consequently the enrichment in solute in the remaining solvent, is partially controlled by conductance of the exhaust path which may include optional means, including for example restrictions, valves, pumps, and/or pressure measurement and feedback. Solvent vapor from the exhaust path of the further exhaust circuit can optionally be condensed at lower temperature surfaces and accumulated in collection reservoirs for appropriate disposal.

The aerosol is further enriched in charged solute particles from the aerosol stream by directing them through the extraction barrier of the interface. The perforated extraction barrier is oriented opposite to the solvent vapor exhaust path of the further exhaust circuit and presents at least one hole to allow the passage of the solute. The extraction barrier further serves to selectively deliver the flow containing charged solute particles into the compression chamber/region of the interface that utilizes influence of both reduced turbulence and electric fields to compress the cross-section of the charged particle beam to a value substantially reduced with respect to the entrance cross-section of the perforated barrier. Residual solvent vapor is removed from the compression zone through the exhaust conduit of the exhaust circuit which may further separate the said particle beam from residual solvent vapor. This exhaust conduit is off-axis in respect of the compressed particle beam. Additionally, the conductance and removal of exhaust solvent vapor by means of the exhaust conduit of the exhaust circuit may be controlled by optional means, including restrictions, valves, pumps, and/or pressure measurement and feedback. Solvent vapor from the exhaust conduit can optionally be condensed at lower temperature surfaces and accumulated in collection reservoirs for appropriate disposal. The reduced cross-section particle beam is sampled through a skimmer lens into a final focusing zone where solute particles are substantially focused, preferably onto a movable deposition surface with a significantly reduced optical sampling cross-section. The charged particle deposition occurs at ambient pressure which significantly enhances transmission efficiency, reproducibility, and detection sensitivity over prior art.

### STATE OF ART

A technique for desolvating a flowing liquid chromatography effluent stream is described in U.S. Pat. No. 8,695,813 and commercialized as the DiscovIR-LC® detection system, which consists of a thermal nebulizer feeding a self-regulating spray drier to produce an aerosol of dried solute particles suspended in the evaporated solvent vapor. A non-condensable gas is added to this aerosol and the mixture flows through a chilled condenser removing most of the solvent vapor by condensation. The non-condensable gas acts as a diffusion barrier to reduce solute particle loss to the condenser walls and to maintain the remaining solute particles in suspension as an aerosol. This aerosol is then drawn through a transfer tube into an evacuated chamber where the aerosol is pneumatically focused and deposited onto an infrared transparent moving substrate with subsequent infrared detection and spectral analysis.

The performance limitations of this prior art are limited sensitivity, loss of chromatographic resolution, and inconsistency or absence of results. This comes principally from the post-evaporation handling of the solute particles suspended in the solvent vapor. The performance limitations of this prior art solution include significant and particle size dependent solute losses from the aerosol during solvent removal and transport, variable capture efficiency during high velocity deposition, and a relatively large area deposit with variable spreading during deposition. A large deposit area results in low deposit thickness and low absorbance. A large area deposit also degrades chromatographic resolution. This prior art solution works acceptably well for some combinations of solvents and solutes, but for other combinations it can be difficult to find suitable operating conditions to reproducibly create small solvent free deposits.

US 2015/0108347 discloses a solution to desolvate ions at near atmospheric pressure in which the solution containing the ions is passed through a couple of electrodes that separate the ionizer from the analyzer. The solution disclosed therein however presents only a single entrance slit to accede to the focusing region, making it complicated to process large amount of solution.

### OBJECTS OF THE INVENTION

The object of the present invention is to provide an improved treatment techniques and apparatus for desolvating flowing liquid streams containing one or more lower-volatility solutes while retaining the chemical and structural integrity and temporal separation of such solutes.

A further object of the present invention is to provide methods and apparatus to continuously remove the volatile solvents from a fluid mixture comprising liquid components and solute components and deposit the desolved, concentrated, structurally integral solutes on the surface for subsequent infrared absorption analysis or other sample deposition applications (FIG. 8).

A further object of the present invention is to minimize the loss of solute and especially the particle size dependency of this loss while separating the solute particles from the solvent vapor.

A further object of the present invention is to minimize the surface area of the deposit while it maximizes the thickness and resulting infrared absorbance, and the number of distinct deposits that can fit on a given size surface.

A further object of the present invention is to reduce solute transport losses observed with trapping at vacuum pressures and reduce recoil losses and spreading from solute particle deposition of high velocity beams associated with vacuum deposition.

A further object of the present invention is to increase sensitivity, improve reproducibility, expand compatibility with different samples and solvents, reduce complexity, cost and required operator expertise over the prior art.

A further object of the present invention is to provide an alternative solution to the ones of the prior art.

More in detail, the solution according to the invention allows to control the geometry, the dimensions (in particular the cross section), the amount and the location of the sample to be deposited on a surface.

Moreover, the solution according to the invention allows to deposit a larger amount of the sample on a smaller area of the surface, thus increasing the sensitivity.

### SUMMARY OF THE INVENTION

All these objects, considered both individually and in any combination thereof, and others which will result from the following description, are achieved, according to the invention, with an interface with the features indicated in the claim 1 and/or in the dependent claims.

In particular, the interface according to the invention for the controlled transport of a solution or suspension mixture at the input toward a target zone, is characterized in that it comprises:
a perforated extraction barrier comprising at least one perforated laminar element with a plurality of holes intended to be crossed by a stream of said mixture, said perforated extraction barrier being positioned at the entry of a compression region configured for reducing the cross-section of the stream,
said compression region being fluidically connected with an opening for the entry of a gas counterflow,
said compression region being fluidically connected with an exhaust circuit for at least one gas, said exhaust circuit is positioned between the perforated extraction barrier and the opening for the entry of a gas counterflow.

Advantageously, said solution or suspension mixture comprises at least one-time intermittent solute component.

Advantageously, the solution mixture contains at least one solvent vapor component and at least one solute component.

Advantageously, the suspension mixture contains at least one solid component with at least one gas/vapor component and/or at least one liquid component.

Advantageously, the compression region comprises at least one lens configured to use the electro-optical compression for reducing the cross-section of the stream.

Advantageously, said gas counterflow is controlled.

Advantageously, the opening for the entry of a gas counterflow is positioned at the outlet/exit of said compression region.

Advantageously, the interface comprises an entry region positioned upstream of the compression region and separated by said perforated extraction barrier, said entry region being fluidically connected with a further exhaust circuit having a flow control (preferably a flow restrictor) positioned upstream with respect to condensing means.

Advantageously, the exhaust circuit of the compression region comprises a flow control (preferably a flow restrictor, or more preferably a positive displacement pump) positioned downstream with respect to condensing means.

Advantageously, the interface comprises an exit/depositing region positioned downstream of the compression region, said opening for the entry a gas counterflow is fluidically connected with said exit/depositing region, said gas counterflow being configured so as to control the delivering of said at least one solute or solid component of the stream on or toward a target zone, preferably to control its depositing on a deposition surface.

Advantageously, the interface is configured for desolvating, at least partially, said fluid mixture vapor.

Advantageously, said mixture is a nebulized and evaporated liquid chromatographic effluent.

Advantageously, said mixture contains electrically charged droplets and/or charged dried particles, preferably with at least one solute component, carried by a vapor of said solvent. Preferably, said at least one solute component is intermittently present in chromatography eluent.

Advantageously, said mixture contains electrically charged droplets with at least one solvent vapor component and at least one solute component and wherein the solvent vapor component has been previously removed partially by evaporation, preferably by film-boiling within a cyclone chamber.

Advantageously, the interface is configured to be positioned at the output of a drier, preferably of a cyclone drier.

Advantageously, the interface comprises, at the entry region positioned upstream of the compression region and of perforated extraction barrier, deflections means configured to direct an entry stream of the mixture, comprising at least one solvent vapor component and at least one solute component, away from a major portion of solvent vapor entering in the further exhaust circuit.

Advantageously, said stream deflection means comprises a repeller electrode.

Advantageously, said stream deflection means comprises a repeller electrode configured to generate orthogonal electric fields relative to the stream of the solvent vapor entering in the further exhaust circuit.

Advantageously, the repeller electrode is configured to direct a mixture stream, comprising a solvent vapor component and at least one solute component, away from a major portion of solvent vapor entering in the further exhaust circuit.

Advantageously, the repeller electrode is configured to direct a mixture stream, comprising a solvent vapor component and at least one solute component, toward and/or in correspondence of the perforated extraction barrier.

Advantageously, the repeller electrode is configured to generate an electric field that repels the charged droplets or particles and the solvent vapor component is entrained and dragged by the repelled droplets/particles.

Advantageously, the repeller electrode is configured to deflect a mixture stream, preferably comprising a solvent vapor component and at least one solute component, away from a major portion of solvent vapor entering in the further exhaust circuit and toward and/or in correspondence of a perforated extraction barrier with a small portion of solvent vapor.

Advantageously, a voltage is applied to the repeller electrode so as to emanate an electric field.

Advantageously, the repeller electrode is configured to emanate an electric field that is orthogonal to the mixture stream.

Advantageously, the repeller electrode is located on the entry section of the vapor exhaust tube of said further exhaust circuit.

Advantageously, the repeller electrode is facing the perforated extraction barrier.

Advantageously, the entry of the vapor exhaust tube of said further exhaust circuit, the repeller electrode and the perforated extraction barrier are facing each other.

Advantageously, the repeller electrode and the perforated extraction barrier are spaced apart.

Advantageously, the repeller electrode is placed in correspondence of the entry of a vapor exhaust tube of said further exhaust circuit.

Advantageously, the vapor exhaust tube of said further exhaust circuit is insulated by thermal insulator.

Advantageously, said further exhaust circuit comprises means for regulating the vapor flow and means for condensing the vapor flow, said flow regulating means being placed upstream in respect of condensing means.

Advantageously, a pressure differential is defined/created across the perforated extraction barrier.

Advantageously, the stream crosses the perforated extraction barrier by means of solvent vapor, preferably by means of a residual small portion of solvent vapor resulting carrying an enhanced concentration of solute containing component from the deflection operated by the repeller electrode.

Advantageously, the perforated extraction barrier comprises at least one perforated laminar element with a plurality of holed defined on the same laminar element.

Advantageously, the perforated extraction barrier comprises at least one perforated laminar element having a planar shape.

Advantageously, the perforated extraction barrier comprises at least one perforated laminar element having a conical shape.

Advantageously, the perforated extraction barrier comprises at least one perforated laminar element having a hemispherical shape.

Advantageously, the perforated extraction barrier comprises at least two perforated laminar elements overlapping and spaced apart of each other.

Advantageously, the perforated extraction barrier comprises at least one inlet for introducing inert gas between two perforated laminar elements overlapping and spaced apart from each other.

Advantageously, the perforated extraction barrier comprises at least two overlapping perforated laminar elements separated by an insulation element.

Advantageously, the perforated extraction barrier comprises at least two perforated laminar elements overlapping and spaced apart from each other.

Advantageously, the perforated laminar element comprises a dual layer perforated element.

Advantageously, the dual layer perforated element comprises a first perforated layer and a second perforated layer separated by an electrical insulator.

Advantageously, the interface comprises means for supplying a voltage difference between the layers of each layer perforated element.

Advantageously, the compression region is configured so that the entering mixture stream is directed axially toward the output (i.e. the target zone) under the influence of both vapor flow and electric field derived by at least on electric-compression lens of the compression region.

Advantageously, the interface comprises a compression region is configured so that the entering mixture stream is electro-optically compressed along the flowing axis of the stream so as to reduce the cross-section of said stream.

Preferably, the compression region is tapered.

Advantageously, the compression region walls are tapered so the entering mixture stream is geometrically compressed along the flowing axis of the stream so as to reduce the cross-sectional area of said stream.

Advantageously, the compression region is positioned just below/at the exit of the perforated extraction barrier.

Advantageously, the compression region comprises a conduit/tubular/conical element, positioned just below/at the exit of the perforated extraction barrier, for receiving the flow exiting from said perforated extraction barrier.

Advantageously, the flowing axis of the stream in the compression region is aligned with the exit of an upstream dryer/evaporator device.

Advantageously, the flowing axis of the stream in the compression region is tilted in respect to the exit of an upstream dryer/evaporator device.

Advantageously, the compression region is fluidically connected and/or is provided with an aperture for receiving a gas counter-flow for the stream of said mixture directed toward a target zone.

Advantageously, the compression region is fluidically connected with a circuit for sending a gas counter-flow for the stream of said mixture directed toward a target zone.

Advantageously, said circuit for sending a gas counter-flow for the stream comprises means for regulating the counter-flow, preferably a valve.

Advantageously, said circuit for sending a gas counter-flow for the stream comprises means for regulating the counter-flow, preferably a positive displacement pump. Preferably, the means for regulating the counter-flow comprises a device configured for extracting two phases, i.e. non condensable gas/air and condensed solvent vapor which is primarily a liquid.

Advantageously, said gas counterflow is free of solvent vapor.

Advantageously, said gas counter-flow comprises gas at ambient pressure.

Advantageously, said gas counter-flow comprises ambient air.

Advantageously, said gas counter-flow comprises at least one inert gas, preferably at least one of the following gases: air, nitrogen, helium, argon.

Advantageously, said aperture for receiving a gas counter-flow is fluidically connected with a regulated gas supply.

Advantageously, the compression region is fluidically connected with the depositing surface for receiving a gas counter-flow for the stream, said gas counter-flow is directed from the region containing said depositing surface towards and within the compression region.

Advantageously, the compression region is fluidically connected with the vapor exhaust circuit for receiving the solvent vapor component of the stream and the gas counter-flow.

Advantageously, the compression region is fluidically connected with a radial vapor exhaust conduit of a vapor exhaust circuit, in particular said vapor exhaust conduit is angled, preferably is perpendicular or near perpendicular, to the stream direction toward the target zone.

Advantageously, the compression region is angled in respect to the target zone, preferably in respect to the deposition surface.

Advantageously, the vapor exhaust circuit of the compression region is provided with flow regulating means placed downstream in respect of corresponding condensing means.

Advantageously, the flow regulating means of the vapor exhaust circuit comprises a passage restrictor toward a lower pressure region.

Advantageously, the flow regulating means of the vapor exhaust circuit comprises a positive displacement flow sink.

Advantageously, the flow regulating means of the vapor exhaust circuit comprises a positive displacement pump, such as a gear pump which can displace liquid gas mixtures.

Advantageously, the compression region comprises a first zone (i.e. the compression zone) placed upstream (according to the flow direction of the stream) to at least one connection with the vapor exhaust circuit and a second zone (i.e. the focusing zone) placed downstream to said at least one connection with the vapor exhaust circuit, thus the stream entering in the second zone has less or is free of solvent vapor with respect to the stream entering or circulating in the first zone.

Advantageously, said first zone (compression zone) comprises only one electric-compression lens.

Advantageously, said first zone (compression zone) comprises a sequence of at least two electric-compression lenses, preferably at least two electrostatic lenses, wherein the downstream lens has an aperture with a smaller diameter in respect to the aperture of the upstream lens.

Advantageously, said second zone (focusing zone) is connected to the vapor exhaust circuit only by passing through the first zone (compression zone), while said first zone (compression zone) is directly connected with the vapor exhaust circuit.

Advantageously, said second zone (focusing zone) comprises a sequence of at least two lenses wherein the downstream lens has an aperture with a smaller diameter with respect to the aperture of the upstream lens.

Advantageously, the first zone and the second zone are separated from each other by a skimming aperture.

Advantageously, the compression region is fluidically connected with an aperture for sending a counter-flow for the stream.

Advantageously, the compression region comprises at least one electro-compression lens, preferably an electrostatic lens, provided with a passing aperture for reducing the cross-section of the stream.

Advantageously, the compression region comprises at least two electro-compression lenses, preferably a plurality of lenses, provided with corresponding passing apertures with cross-section reducing according the direction of flow of the stream.

Advantageously, said at least two lenses are positioned so as to face each other.

Advantageously, said at least two lenses are positioned along a curved or angled tube.

Advantageously, at least one lens of the compression region is associated to means for voltage supply for generating an electric field concentrating the particles in the stream on the axis of the compression tube.

Advantageously, the interface comprises a focusing (a second compression) zone positioned downstream of said first/compression zone.

Advantageously, said focusing zone comprises at least one electro-compression lens, preferably an electrostatic lens, that is provided with a passing aperture for reducing the cross-section of the stream.

Advantageously, said focusing zone comprises at least one electro-compression lens, preferably an electrostatic lens, provided with a passing aperture for reducing the cross-section of the stream and for directing the stream, without solvent or with a reduced amount of solvent, onto a depositing surface.

Advantageously, the depositing surface is placed in front of the compression region, preferably in front of the exit of said second zone of the compression region.

Advantageously, the depositing surface is at ambient pressure.

Advantageously, the depositing surface is movable.

Advantageously, the depositing surface is a surface suitable for analysis, preferably for chemical analysis.

Advantageously, the depositing surface is an optical surface for infrared spectroscopy analysis.

Advantageously, the interface comprises means for neutralizing the charge upon the sample surface.

Advantageously, said means for neutralizing the charge upon the sample surface comprises means for conducting excess charge away from the depositing surface.

Advantageously, said means for neutralizing the charge upon the sample surface comprises means for adding ions or electrons that are opposite the polarity to the charged solute particles collected on the depositing surface.

The present invention further refers to a spray device for converting/dividing a liquid stream into an electrically charged spray (jet of vapor and/or droplets), wherein it comprises:
Thermal means for converting/dividing the liquid stream into droplets,
Means for electrically charging the droplets of the liquid stream,
   and wherein an electric voltage is applied on one of said means while the other means are grounded.

Advantageously, in the device, a voltage is applied on the means for electrically charging the droplets, while the thermal means are grounded.

Advantageously, in the device, insulating means are provided for electrically insulating the means for electrically charging the droplets from the block wherein said electrically charged spray enters.

Advantageously, in the device, a voltage is applied on the thermal means, while the means for electrically charging the droplets are grounded.

Advantageously, in the device, insulating means are provided for electrically insulating the thermal means for converting/dividing the liquid stream into droplets from the block wherein said electrically charged spray enters.

Advantageously, in the device, the thermal means for converting the liquid stream into droplets comprises a thermal nebulizer.

Advantageously, in the device, the thermal means are configured to boil the flowing liquid stream so as to derive a solvent vapor for carrying downstream the electrically charged droplets.

Advantageously, in the device, the means for electrically charging the droplets of the liquid stream comprises an induction electrode connected with a voltage supply.

Advantageously, in the device, the induction electrode is positioned in axis with and downstream of the thermal nebulizer.

Advantageously, in the device, the liquid stream corresponds to an LC effluent.

Advantageously, in the device, the resulting/exiting electrically charged spray comprises a jet of liquid electrically charged droplets and/or electrically charged solid particles suspended or entrained in a gas-phase fluid.

The present invention further refers to an apparatus comprising:
means for generating an aerosol from a liquid flow comprising at least one-time intermittent solute component.
means for desolvating and evaporating said aerosol,
an interface with one or more of the above mentioned features that is positioned at the exit of said means for desolvating and evaporating said aerosol and that receives as input a solution mixture containing at least one solvent vapor component and at least one solute component, preferably electrically charged, so as to deliver as output said at least one solute on a target zone, preferably on a depositing surface.

Advantageously, in the apparatus, the means for generating an aerosol comprises a spray device as above indicated.

Advantageously, in the apparatus, the means for desolvating and evaporating said aerosol comprises a cyclone evaporator.

The present invention further refers to a spray-dryer apparatus comprising an upstream spray device according to one or more of the previous claims and a dryer device configured so as to reduce the solvent/liquid component of an electrically charged spray received by said upstream device, preferably said spray comprising electrically charged liquid/solvent droplets and/or electrically charged solid particles suspended or entrained in a gas-phase fluid.

Advantageously, in the spray-dryer apparatus, the dryer device comprises evaporating means for removing/reducing by film-boiling the liquid/solvent component of an electrically charged spray, said drier being configured to receive as input the electrically charged spray generated by said spray device.

Advantageously, in the spray-dryer apparatus, said evaporating means for removing/reducing by film-boiling the solvent of an aerosol jet comprises an assembly configured for circulating the entering jet spirally downward.

Advantageously, in the spray-dryer apparatus, said evaporating means for removing/reducing by film-boiling the solvent in an entering aerosol jet comprises a heated chamber with a cylindrical cavity.

Advantageously, in the spray-dryer apparatus, the chamber of the dryer device is configured as a cyclone chamber.

Advantageously, in the spray-dryer apparatus, the dryer device is configured so that the high speed electrically charged aerosol jet is directed circumferentially around the internal surface of a heated, generally toroidal, cavity of a chamber, thus creating a high degree of vorticity.

Advantageously, in the spray-dryer apparatus, the cavity chamber of the dryer device has a generally toroidal shape.

Advantageously, in the spray-dryer apparatus, the cavity chamber of the dryer device is crossed centrally by the exhaust tube of said further exhaust circuit.

Advantageously, in the spray-dryer apparatus, the inner surface of the cavity chamber of the dryer device is heated, preferably heated above the boiling point of the liquid component of the entering fluid stream.

Advantageously, in the spray-dryer apparatus, the inner surface of the cavity chamber of the dryer device is maintained heated at a temperature that is of at least 100° C. hotter than the boiling point of the liquid component of the entering fluid stream.

Advantageously, in the spray-dryer apparatus, an interface according to one or more of the above-mentioned features is positioned at the exit of the dryer device.

The present invention further refers to an apparatus for combining liquid chromatography to infrared spectroscopy analysis, said apparatus comprising:
a sample solution separated by liquid phase techniques to isolate individual sample components contained within the sample in both time and space to deliver a flowing stream containing said individual components to an aerosol generation means,
a thermal vaporizer heated to generate a population of charged droplets from said flowing stream carried downstream by solvent vapor derived from boiling of the said flowing stream within the said thermal vaporizer,
a cyclone chamber to receive said charged droplets at or near said chamber walls, said walls heated to provide adequate thermal energy to facilitate film evaporation of said droplets to desolvate said charged droplets to produce solvent-depleted charged solute particles and substantially all droplet solvent as solvent vapor, said solute particles directed away from the walls of the said chamber by flow of said solvent vapor stream,
an exhaust port to exhaust solvent vapor positioned on the axis of the said cyclone chamber to exhaust most of the solvent vapor,
a particle deflection electrode (repeller electrode) to direct the motion of said solvent-depleted electrically-charged solute particles orthogonal to the bulk exhaust flow of the solvent vapor and toward a particle extraction barrier located on an opposing surface of the said deflection electrode to concentrate said charged particles near the extraction barrier,
a perforated extraction barrier positioned between the cyclone chamber and a downstream compression region to facilitate the extraction of said charged solute particles from the cyclone chamber, said barrier providing flow of enriched/dried particles into a downstream compression region,
a compression zone to compress stream of said enriched particles on the axis of said region using electro-optical compression to more fully enrich the concentration of said particles,
one or more compression lenses located within said compression zone held at an electrical potential to facilitate concentration of the said enriched particles relative to the residual solvent vapor emanating through the extraction barrier into the compression region,
an aperture lens to skim enriched particles from the compression zone to deliver a more highly solvent-depleted particle population into a focusing zone,
a focusing zone structured to fluid-electro-optically focus the said particle population onto a sample deposition surface.
a sample deposition region located adjacent to the focusing zone to house the said sample deposition surface and provide for temporal manipulation of the deposition surface to collect a temporal record of deposition spots or ribbons for subsequent detection and chemical analysis.
a counter-flow gas emanating from the region surrounding the sample deposition surface into the focusing zone to prevent residual solvent vapor from passing into the deposition region while also providing enhanced fluid dynamical focusing of particles passing onto the deposition surface,
an infrared spectrometer to analyze the identity and quantity of individual components from the sample are measured.
control means for optimization and feedback of temperature, flow, voltages, pumping, . . .
control means to manipulate and store a temporal record of the sample deposition upon the deposition plate,.

Preferably, the apparatus is configured so that the solvent is exhausted and lost to the atmosphere.

Preferably, the apparatus further comprises a reservoir for collecting condensed solvent vapor from exhaust of the cyclone region.

Preferably, the apparatus further comprises reservoir for collection condensed solvent vapor from exhaust of the compression region.

Preferably, the plate is removable and storable for later analysis.

Advantageously, the control means comprises a perforated extraction barrier flow control by differential pressure created by restriction of solvent vapor exhaust from cyclone before condensation at essentially atmospheric pressure.

Advantageously, the control means comprises a counterflow rate of dry gas by flow control after condensation so as to regulate only the non-condensable dry gas flow independent of the condensable solvent vapor flow.

The present invention further refers to a method for combining liquid chromatography to infrared spectroscopy analysis, said method comprising preferably in sequence, the following steps of:
delivering a solution of sample components dissolved in mobile phase eluting from a liquid chromatograph or other liquid phase separation techniques,
generating an aerosol (thermal) from eluent from said solution to produce liquid droplets swept into a desolvation region by gas-phase solvent vapor produced within the said aerosol generation process,
desolvating said liquid droplets produced by thermal aerosol generation by directing said droplets toward a heated surface under conditions of film evaporation to enable complete evaporation of said droplets to produce dry charged solute particles carried in a bulk stream of solvent vapor.
exhausting said sample depleted solvent vapor and condensing said vapor into a lower pressure collection reservoir.
extracting said dry charged solute particles from said bulk stream of solvent vapor using orthogonal electric fields relative to streamlines of bulk solvent vapor flow to product a population of enriched dry charged solute particles to be removed from the desolvation region across an attractive and permeable extraction barrier to a lower pressure compression region,
compressing said population of extracted solute particles within said compression region to concentrate and further enrich said particles along the axis of flow with one or more compression lenses,
further exhausting residual solvent vapor from compression region to a lower pressure reservoir for condensing and collecting solvent vapor,
skimming the said compressed solute particles on the axis of flow of the compression region to deliver the said particles into a focusing zone,
focusing the population of skimmed solute particles with one or more focusing lenses for deposition of said particles onto the surface of a sample collection plate,
further focusing and enriching/concentrating the skimmed particles from residual solvent vapor by flowing inert counter-flow gas through at least one focusing lens allowing the solute particles to be pushed to a higher-pressure deposition region,
depositing the focused solute particles onto a micron dimensioned diameter collection spot for detection and analysis with FTIR,
neutralizing the charge upon the sample surface by conducting excess charge away from the surface or adding ions or electrons that are opposite the polarity to the charged solute particles collected on the surface,
positioning the deposition surface relative to the incident focused beam of solute particles to physically store a temporal record of the eluents from the said sample.

### DESCRIPTION OF FIGURES

The present invention is further clarified hereinafter in some of its preferred embodiments reported for purely illustrative and non-limiting purposes with reference to the attached drawing tables, in which:

FIG. 1 shows a flow diagram of the functional processes of a spay-dryer apparatus/method including: charged aerosol generation, desolvation by film evaporation, enrichment (i.e. solvent vapor separation) by applying orthogonal field relative to the streamlines of flow, extraction of solvent-depleted charged solute particles by migration through a selective extraction barrier, compression of particles to a concentrated beam, and focusing the beam onto a lower-dimensioned cross-section deposition spot for subsequent detection and analysis.

FIG. 2 shows a preferred embodiment of an apparatus with the LC-FTIR interface according the invention. The apparatus introduces eluent into a thermal vaporizer producing partially solvent-depleted charged droplets carried by solvent vapor into a toroidal geometry film evaporator (cyclone) to complete desolvation using a self-regulating process that delivers solvent-depleted solute particles toward the center axis of the cyclone where charged particles are deflected toward an extraction barrier of the interface, then transmitted and compressed into a narrow particle beam, and focused onto a sample particle collection surface, preferably to be analyzed then by Fourier Transform Infrared Spectroscopy Detection.

FIG. 3 shows a particular of the interface of FIG. 2 wherein, in particular, the total cyclone evaporator output flow is split between the solute enriched charged aerosol flow through the extraction barrier of the interface and the majority flow of solvent vapor through the split ratio controlling flow restriction in the heated region of the cyclone exhaust line. Cyclone exhaust solvent vapor can preferably be condensed and collected after the flow restriction. In the compression region of the interface, electrostatic fields isolate the charged solute particles from residual solvent vapor and the non-condensable counterflow gas entering from the focusing zone. The residual solvent vapor and the non-condensable gas is removed from the compression region through the compression exhaust. This flow is first condensed to minimize the volume of the solvent vapor, and then evacuated by a peristaltic, diaphragm, gear, positive displacement, or other flow regulating pumping means to regulate the non-condensable counter-flow gas velocity through the focusing zone. The flow through the pumping mean may optionally include, exclude or partially exclude the condensed solvent vapor. Solvent vapor from both exhaust circuits is condensed and preferably collected into reservoirs. Solute particles are electrostatically focused from the compression zone through the focusing zone to a sample collection surface held at ambient pressures. The charged particles are further focused by the counter-flow of ambient gas held at or near ambient pressure—from the deposition region to the compression region.

FIGS. 4a-FIG. 4c show three alternative embodiments for extraction barriers of the interface are illustrated here to show matching of specific extraction barrier geometry and complexity to the aerosol properties, cyclone geometries, and the flow and composition of the sample stream passing near between the repeller and the specific extraction barrier. In particular, FIG. 4a shows a planar configuration of the extraction barrier, FIG. 4b shows a conical configuration of the extraction barrier, and FIG. 4c shows a hemispherical configuration of the extraction barrier.

FIG. 5 shows a further embodiment of the laminated extraction barrier of the interface according to the invention, comprising two dual layer perforated elements to achieve enhanced control over both control of flow of charged solvent-depleted particles and field applied said particles to move them across the barrier into downstream compression region. A unique component of this embodiment is the addition of carrier gas between the first layer and the second layer to more fully eliminate solvent vapor from cyclone side of barrier from flowing into the compression region; conveniently, the voltage differences between each layer in the laminates attracts the charged particles across the laminated barrier while preventing passage of solvent vapor.

FIGS. 6a-FIG. 6c show three alternative embodiments for compression zone and focusing zone can be configured for delivery to remote sample collection surfaces; namely, FIG. 6a) shows an axial configuration, FIG. 6b) shows a configuration with uniform field extensions, and FIG. 6c) shows a configuration with non-axial uniform field extensions. Drawings are displayed using output from SIMION version 8.1 to calculate motion of particles through the interface under representative flow and field conditions.

FIGS. 7a and 7b show embodiments of the current invention to utilize inductive charging of droplets emanating from the thermal nebulizer 204. In particular, FIG. 7a relates to a first embodiment wherein there is a grounded thermal nebulizer 204 with a floating induction electrode, while FIG. 7b relates to a second embodiment wherein there is a floating thermal nebulizer 204 with a grounded induction electrode.

FIG. 8 shows a scheme of the applications space of the interface according to the invention, that can be used for deposition of a wide variety of sample materials onto target surfaces for temporal, spatial, and compositional control of surface material. Although chemical analysis with LC-FTIR is a primary object of the invention, it is intended that the invention has a wide variety of applications for precise and quantitative delivery of material to any surface.

FIGS. 9a-9c show, according to three different modeling views, the focusing motion of particles from a compression tube, through a single lens, and onto a sample collection surface using three modeling views; namely, FIG. 9a shows a 2D view, FIG. 9b shows a view of the potential surface, and FIG. 9c shows a 3D view. Drawings are displayed using output from SIMION version 8.1 to calculate motion of particles through a single lens under representative field conditions.

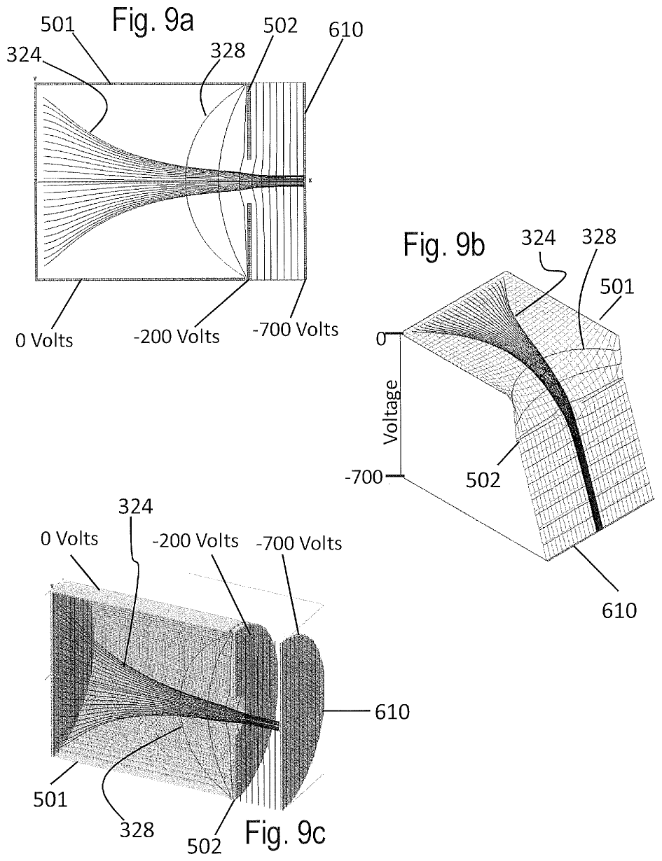

### DESCRIPTION OF THE INVENTION

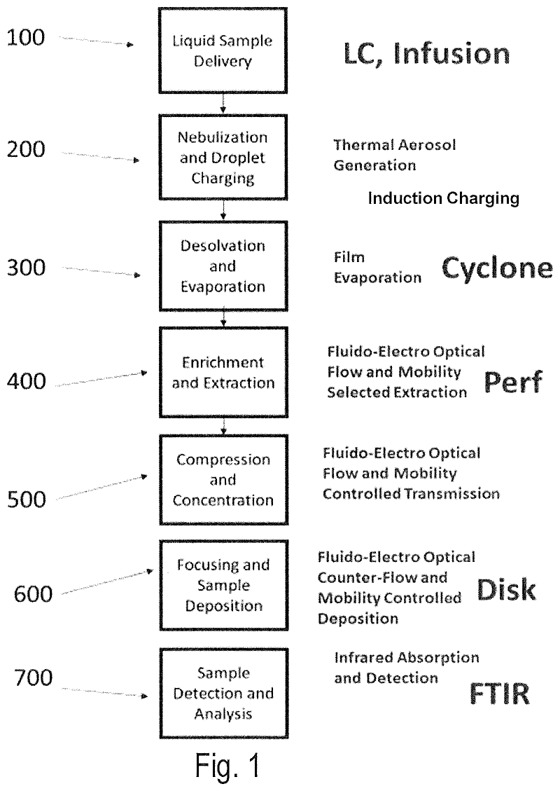

In general, the transport interface according to the invention may be used in methods and apparatus consisting of a series of process steps or stages (FIG. 1), and related apparatus components, that comprise a novel spray drier system (200 and 300) for processing a flowing liquid stream 100 containing low volatility components by removing the volatile liquid solvent component and leaving the low-volatility solute components. In some applications of this invention, the low-volatility components will be temporally and spatially separated from each other in the same relation as they were in the original untreated stream. The fluid stream may, for example, consist essentially of a liquid solvent that may change in composition as treatment in accordance with this invention progresses. The fluid stream may carry a variety of dissolved and/or dispersed solid and/or liquid components, each of which is typically carried in a short section of the stream, frequently as the only dissolved component in that section. The solvent portion of the stream may be comprised of any suitable liquid.

Among other applications, this invention may specifically or mainly be applied to treating the eluate from a high-pressure liquid chromatograph instrument, with typical liquid flow rates ranging from about 0.1 to 2 ml per minute. All such LC eluate may be processed according to the present invention. Alternatively, a portion of such LC eluate may be treated in accordance with this invention, while another portion may be directed to another instrument, such as a mass spectrometer, or collected for other purposes, or not utilized at all. In a typical liquid chromatography application, the liquid consists essentially of organic solvents, or water mixed with a varying concentration of one or more miscible organic solvents, and may additionally contain varying concentrations of one or more additives. The water, organic solvents, and volatile additives, if present, can all be substantially removed or separated from the low-volatility components by the methods and apparatus according to the invention.

The apparatus according to the invention preserves the chemical and structural integrity, as well as the temporal resolution, of the low volatility components (the solutes) while desolvating the liquid stream/droplets. More in detail, the apparatus according to the invention is configured for evaporating the liquid droplets in a liquid stream, thus increasing the concentration of the solute(s). The dried solute may be further conditioned by means of an interface 350 that is configured to extract (by/in the extraction and enrichment zone 400), compress (by/in the compression zone 500), and focus (by/in the focusing zone 600) the dried solute onto a solid surface, or collected as a solid, powder or liquid.

In one preferred embodiment, the liquid stream at the input of the apparatus is a chromatographic effluent, and the dried solute at the output of the apparatus (and also of the interface) is deposited as a small spot or stripe on a surface for a further analysis and detection 700, in particular for an infrared spectrographic analysis.

The term “solute” as used in this disclosure is hereby defined as and intended to include dispersed and suspended, as well as dissolved solids and relatively low vapor pressure liquids.

The apparatus further comprises in part (in particular at the input) aerosol generating means provided with a nebulizer which converts the liquid stream into a high speed electrically charged aerosol jet which is then directed into desolvation and evaporation means comprising a cyclone, in particular is directed circumferentially around the inside surface of a heated, generally toroidal cavity of a chamber of the cyclone, thus creating a high degree of vorticity.

As used herein, the term “aerosol” is hereby defined to include charged liquid droplets and/or charged solid particles suspended or entrained in a gas and/or vapor-phase fluid.

Centrifugal force, which can be provided by the jet velocity, causes the larger charged liquid droplets to travel along the outer diameter of the cavity. The cavity inner surface is heated to a temperature typically at least 100° C. above the boiling point of the liquid component of the fluid stream, to cause the droplets approaching that surface to “film boil”. Film boiling rapidly evaporates solvent from the droplets. In film boiling, the rapid release of freshly evaporated solvent vapor creates a gas layer adjacent the heated surface that prevents droplet contact with the cavity wall, thereby retaining the solute in the droplets. To ensure that the phenomenon of “film boiling” occurs in the chamber cavity, the heated inner surface of the cavity should be maintained at a temperature that is typically at least 100° C., hotter than the boiling point of the liquid component of the fluid stream being treated. The solute is protected from thermal damage by the combination of a short residence time and by being inside the droplet, which is cooled by solvent evaporation.

When the droplets have evaporated to a sufficiently small size, Stokes drag forces from the exiting solvent vapor will exceed the centrifugal force and carry the charged droplets out of the chamber, for example along the central axis of the cylindrical cavity. For convenience, the term “cyclone” will be used herein to indicate the chamber/cylindrical cavity assembly 322 as described above. After the droplets leave the cyclone inner surface, heat exchange with the superheated solvent vapor further dries the droplets. The circulating aerosol spiral downward and spiral through the thin gap between the repeller electrode 310 and the perforated extraction barrier 402. The repeller electrode 310 electrostatically directs the solvent-depleted charged solute particles away from the sample-depleted solvent vapor exhaust tube 312 toward, and concentrates them adjacent to, the surface of the opposing perforated extraction barrier 402. The high vorticity induced surface velocity creates a high shear boundary layer adjacent to the perforated extraction barrier 402 which minimizes sample particles contact. Solvent vapor flows through the perforated plate that serves to drag a major portion of the charged particle through the perforations and into an adjacent compression region 500. The axis of the compression region 500 may optionally be tilted with respect to the cyclone 322. The compression region 500 may optionally be tapered, or conical with the outlet having a smaller cross section than the inlet. Flow through the perforated extraction barrier 402 is controlled by the perforation pore size and the elevated pressure created by the cyclone solvent vapor exhaust circuit 311 (i.e. the further exhaust circuit) being flow restricted by cyclone exhaust vapor tube 312 or other solvent vapor flow restrictions prior to the optional but preferred solvent vapor condensing, typically at near atmospheric pressure. The electric field emanated from voltages applied to the repeller electrode 310 positioned opposite the charged particle stream from the said perforated extraction barrier 402. In the preferred embodiment as illustrated, the repeller 310 is positioned at the entrance of the cyclone vapor exhaust circuit 311. The charged solute particles are carried down the axis of the compression tube 501 and compressed on the axis of the tube preferably by an electric field created by one or more compression lenses (502) to substantially reduce the cross-section of the beam of particles, whereby the said beam is delivered into a focusing zone 600 through an opening in a compression lens 504. The compressed charged particle beam is transmitted through the focusing zone 600 whereby particles are focused preferably through an electric field created by one focusing lens 601, or more lenses 602 onto the surface of a sample collection surface 608 for subsequent analysis 700, in particular with an infrared spectrometer.

In one preferred embodiment according to the invention, the compression region 560 comprises a single lens 504. Conveniently, the compression region 560 comprises a compression well, preferably a tapered portion, that is defined above the compression lens 504 and provides the compression function. Conveniently, the compression lens 504 can also provide the electrostatic focusing directly onto the deposition surface 610. The gas counterflow 606 from the deposition surface/region assists in focusing the deposit. Preferably, this embodiment requires only the single lens 504.

More in detail, the compression region 560 comprises a first zone (i.e. the compression zone 500) placed upstream (according to the flow direction of the stream) to at least one connection with the exhaust circuit 508 and a second zone (i.e. the focusing zone 600) placed downstream to said at least one connection with the exhaust circuit 508, thus the stream entering in the second zone 600 has less or is free of solvent vapor in with respect to the stream entering or circulating in the first zone 500.

The lens or lenses 502, 504 and/or 601, 602 in the compression region 560 are means for reducing the cross section of the flow stream. Preferably, each lens 502, 504 and/or 601, 602 comprises an electrified plate (i.e. on which a voltage is applied) that is provided with a passing hole for the flow stream, in particular for reducing the cross-section of said flow stream.

The compression zone 500 is mainly configured for removing the solvent, while the focusing zone 600—that is directly opened to the environment for the entrance of the gas counter-flow—is mainly configured to control the sample deposition.

### Description of the Preferred Embodiments

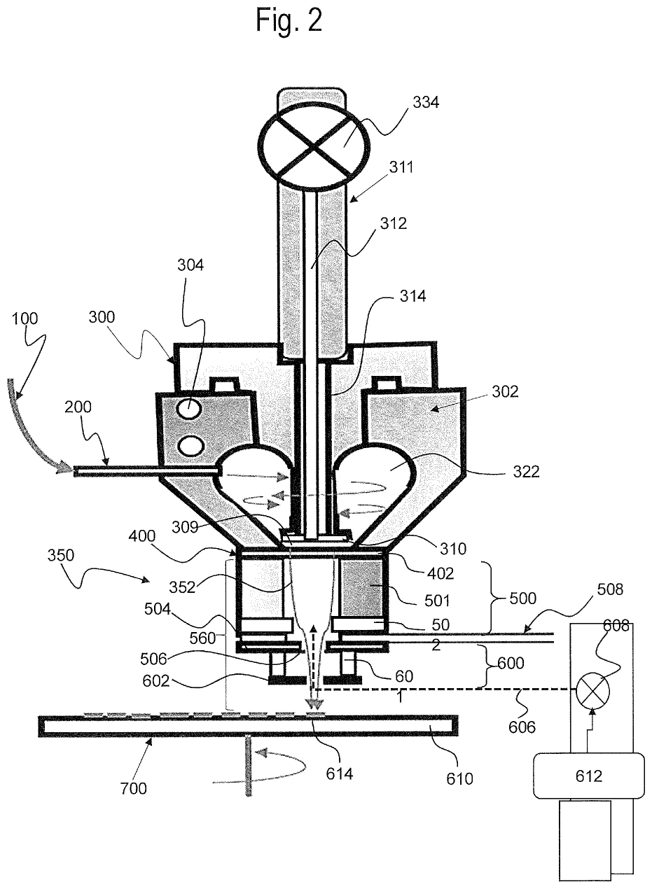

### The Spray-Dryer Apparatus (see FIG. 2)

The present invention discloses an apparatus as schematically depicted in FIG. 2, which illustrates a preferred version of an apparatus for desolvating and/or concentrating flowing liquid streams while retaining temporal separation and collection of purified solute particles onto a collection surface for further treatment or analysis. Liquid-phase separation techniques are generally well known in this art. Preferably, the means for introducing a liquid sample 100 comprises a typical Liquid Chromatography (LC) system that consists of a pump, injector with a sample loop, sample loading syringe and column. The LC system delivers the combined sample and solvent (mobile phase) stream into a chromatography column.

The output of the liquid sample introduction means 100 is fluidically connected to aerosol generating means 200 comprising a thermal nebulizer 204 that is electrically heated. In particular, the LC eluent flows through a capillary that is connected to an electrically (in particular resistively) heated thermal nebulizer 204. In particular, the LC effluent (i.e. the flowing liquid sample stream exiting from LC), or a portion thereof, is nebulized by the nebulizer 204, that is converts the liquid stream into an aerosol stream containing gas and/or solvent vapor with electrically charged liquid droplets and/or electrically charged solid particles.

Conveniently, the nebulizer 204 is configured to produce an aerosol that is “self”-nebulized by virtue of solvent boiling within the heated thermal nebulizer 204. In particular, the expanding solvent vapor develops a sonic or near sonic gas stream emanating from the spray tube which creates a pneumatic disruption of the liquid surface within the tube that results in small sized droplets with a net charge.

The aerosol generation means comprises suitable control means, in particular control and measurement means of the thermal nebulizer 204. Furthermore, the aerosol generation means comprises a mechanical and fluidic connection of the thermal nebulizer 204 with the cyclone block 302, and/or mounting means (for example a bracket) for the thermal nebulizer.

The aerosol generating means 200 are fluidically connected with desolvation and evaporation means 300 that are preferably configured as a cyclone.

In particular, the thermal nebulizer 204 is fluidically connected to an inner chamber 322 of the cyclone block 302 that is provided with means 304 for the controlled heating the internal wall of the cyclone chamber 322. In particular, the partially desolvated sample droplets from the nebulizer 204 are directed toward the inner wall of the cyclone chamber 322 held at sufficiently high temperature to promote “film evaporation” of said droplets, a condition that allows droplets to levitate along the cyclone chamber wall, carried on a gas barrier provided by evaporating solvent. As this process persists, the solvent is substantially removed from the droplet, and the resulting solvent-depleted solute particles are pushed away from the wall surface and carried toward the cyclone exhaust vapor tube 312 by the bulk solvent vapor flow.

The interface 350 according to the invention acts downstream of the cyclone and, in particular, is positioned at the exit of the cyclone chamber 322.

More in particular, at the exit of the cyclone chamber 322, the dried and charged solute particles are then segregated from the bulk solvent vapor flow before the latter enters the cyclone exhaust tube 312 by deflecting the said particles with an orthogonal electric field generated from a repeller electrode 310 of the interface 450, that is located on the circumference of the cyclone exhaust vapor tube 312.

The repeller electrode 310 is held at an electric voltage relative to the cyclone chamber 322 that deflects the charged solute particles in the direction of a perforated extraction barrier 402. The major portion of solvent vapor flow is exhausted through the cyclone exhaust vapor tube 312.

The segregated charged solute particles are directed through a plurality of holes in the perforated extraction barrier 402 by flow of a small fraction of the solvent vapor that carries the particles into a compression region 560.

By having a perforated extraction barrier 402 comprising at least one perforated laminar element with a plurality of holes, it allows to reduce charged particle loss from impacting the perforated laminar element, thus reducing/avoiding the lose of the charge.

More in detail, the compression region 560 comprises a first zone 500 (i.e. the compression zone) placed upstream (according to the flow direction of the stream 352) to at least one connection with the exhaust circuit 508 and a second zone 600 (i.e. the focusing zone) that is placed downstream to said at least one connection with the vapor exhaust circuit 508, thus the stream 352 entering in the second zone 600 has less or is free of solvent vapor in with respect to the stream 352 entering or circulating in the first zone 500.

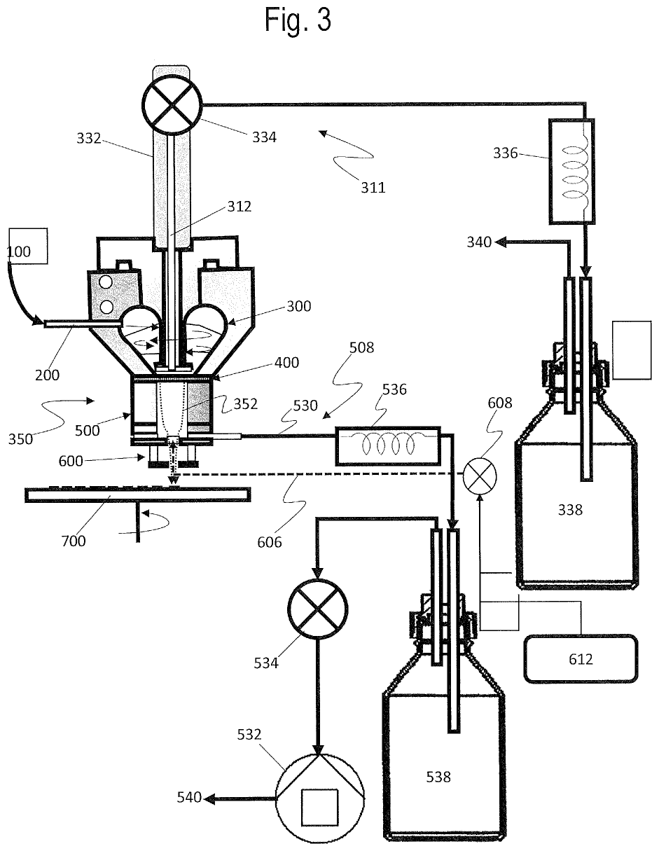

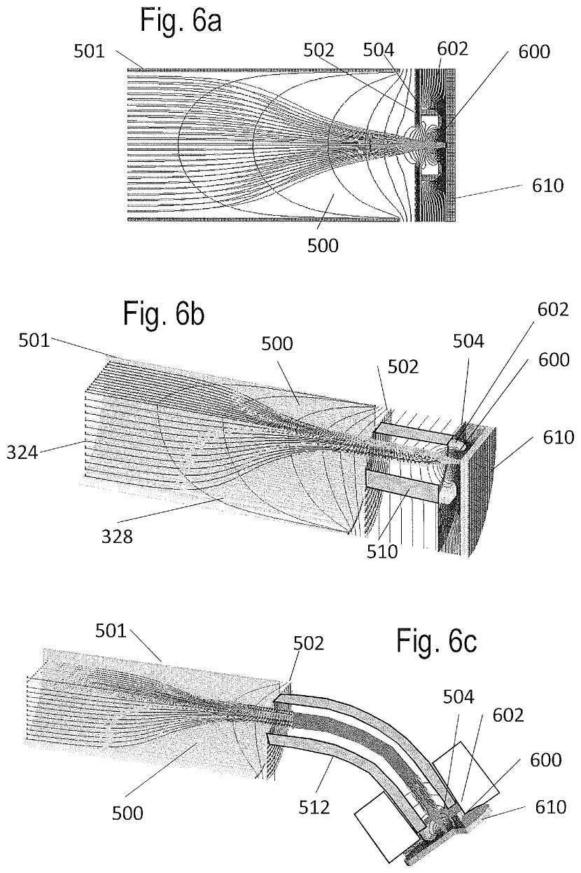

The charged solute particles are directed axially down a compression tube 501 of the compression region 560 under the influence of both vapor flow and electric field derived from attractive or repulsive voltages applied to compression lenses 502 and 504 provided in said compression region 560. The charged solute particles are electro-optically compressed along the axis of tube 501 to form a lower cross section beam of particles (see for example FIG. 6 for particle mobility simulations). Tube 501 may be generally conical with a smaller cross-sectional exit to further reduce the beam cross section. The compressed beam of charged solute particles are further enriched/separated by skimming the compressed charged particle beam through aperture 506 and delivered into the focusing zone 600. The residual vapor flowing through the compression region 560 is removed radially through the compression vapor exhaust circuit 508. In particular, the residual sample-depleted solvent vapor is removed by exhausting through an exhaust conduit 530 of the compression exhaust circuit 508 and condensed into a reservoir 538, as discussed in a more detailed way later with reference to FIG. 3.

The condenser 536 of the exhaust circuit 508 condenses the solvent vapor which is exhausted by a flow control device (see for example the pump 532 and the restrictor 534), thus regulating the amount of a non-solvent vapor gas which is drawn through an aperture into the focusing zone 600 and creates a gas counter-flow 606 in skimming aperture 506. The skimmed beam of charged solute particles entering the focusing zone 600 is highly focused onto the sample collection surface 610, preferably disk-shaped, to form a microscopic sample spot 614.

The focusing of solute particles is influence by both the electric field and the flow; namely, flow in the form of counter-current gas 606 emanating from the sample deposition region and creating a temporal record of depositions onto the rotating sample collection surface 610. Rotation of the surface 610 allows a continuous temporal-resolved collection of the deposits which travel through the focal point of an optical incident beam of infrared light for detection and acquisition of an infrared spectrum. The specific sample spots 614 are a recorded temporal image of the material delivered to the collection disk, enabling the construction of a chromatographic record of the material eluted from the liquid chromatograph. The disks can optionally be saved, stored, and re-analyzed for future reference for both position, time, and composition.

### The Transport Interface 350 (see FIG. 3)

The present invention further relates to an interface 350 for the controlled transport of a solution or suspension mixture at the input toward a target zone, wherein it comprises:
a perforated extraction barrier 402 comprising a plurality of holes intended to be crossed by a stream 352 of said mixture, said perforated extraction barrier 402 being positioned at the entry of a compression region 560 configured for reducing the cross-section of the stream 352,
said compression region 560 being fluidically connected with an opening for the entry of a gas counterflow 606,
said compression region 560 being fluidically connected with a exhaust circuit 508 that is positioned between the perforated extraction barrier 402 and the opening for the entry of a gas counterflow 606.

Advantageously, the interface 350 is positioned between the exit of the evaporator means 300, preferably an evaporator, and a target zone, preferably defined by a deposition surface 610.

Advantageously, the structure and the operation of the evaporator means 300 may correspond to that of the cyclone as disclosed in U.S. Pat. No. 8,695,813, the content of which is entirely incorporated herein by reference. More in detail, the evaporator means 300 positioned upstream of the interface 350 are associated and/or provided with a vapor exhaust tube 312.

The vapor exhaust tube 312 is fluidically connected with the further exhaust circuit 311 comprising means 334 for regulating the vapor flow that are placed upstream in respect of second condensing means 336.

The perforated extraction barrier 402 is positioned at the entry of a compression region 560 that is configured for reducing the cross-section of the stream 352.

The opening for the entry of a gas counterflow 606 is positioned at the outlet/exit of said compression region 560.

The exhaust circuit 508 of the compression region 560 comprises a flow control (preferably a positive displacement pump 532 such as a gear pump or a flow restrictor 534 in combination with a low pressure flow sink/suction pump/vacuum pump 532) positioned downstream with respect to a condenser 536.

The interface 350 comprises an entry region 309 positioned upstream of the compression region 560 and separated by said perforated extraction barrier 402, said entry region 309 being fluidically connected with the further exhaust circuit 311 having a flow control (preferably a flow restrictor 334) positioned upstream with respect to second condensing means 336.

At the entry region 309 positioned upstream of the compression region 560 and of perforated extraction barrier 402, there are deflections means—in particular a repeller electrode 310—configured to direct an entry stream 352 of the mixture, comprising at least one solvent vapor component and at least one solute component, away from a major portion of solvent vapor entering in the further exhaust circuit 311.

The repeller electrode 310 is configured to emanate an electric field that is orthogonal to the mixture stream 352. In correspondence of the exit hole of the cyclone chamber 322 and/or in correspondence of the entry of the cyclone exhaust tube 312 is positioned the repeller electrode 310.

The repeller electrode 310 is located on the entry section of the vapor exhaust tube 312 of said further exhaust circuit 311 and is facing the perforated extraction barrier 402. The repeller electrode 310 and the perforated extraction barrier 402 are spaced apart. In particular, the entry of the vapor exhaust tube 312 of said further exhaust circuit 311, the repeller electrode 310 and the perforated extraction barrier 402 are facing each other. More in detail, the perforated extraction barrier 402 is facing the repeller electrode 310, the exit hole of the cyclone chamber 322 and the cyclone exhaust tube 312.

Conveniently, the bulk of the charge is carried by the particles/droplets. The electric field from the repeller electrode 310 drives (concentrates) the charged solute containing particles and or droplets toward the perforated extraction barrier 402. The high shear flow and the multiple perforations allow a sizable portion of the charged particles to travel through the perforations, rather than be discharged by impacting the plate. In particular, this high shear preventing particle contact with the plate is sometimes called “tangential flow filtration” or “cross-flow filtration”. Preferably, a pressure differential across the perforated extraction barrier 402 causes the vapor to flow through the perorations. The charged particles and or droplets are primarily viscously dragged through the perforations by the flowing gas. Advantageously, the electric field of the repeller electrode 310 assists the flow in carrying the concentrated mixture through the perforations.

The compression region 560 is positioned just below/at the exit of the perforated extraction barrier 402.

The compression region 560 comprises a conduit/tubular element 501, positioned just below/at the exit of the perforated extraction barrier 402, for receiving the flow exiting from said perforated extraction barrier.

In one preferred embodiment, the compression region 560 may comprise only a single lens 504. The compression region 560 comprises at least one lens 502, 504, 601, 602 configured to use the electro-optical compression for reducing the cross-section of the stream 352. In particular, the compression region 560 comprises at least one lens 502, 504, 601, 602, wherein each lens comprises an electrified plate (i.e. on which a voltage is applied) that is provided with a passing hole for the flow stream 352.

The compression region 560 is fluidically connected with an aperture for sending a counter-flow gas 606 for the stream 352. The compression region 560 comprises at least one compression lens provided with a passing aperture for reducing the cross-section of the stream 352.

More in detail, the compression region 560 comprises at least two compression lenses 502, 504, 601, 602, preferably a plurality of lenses, provided with corresponding passing apertures with cross-section that reduce according to the direction of flow of the stream 352. Advantageously, said at least two lenses 502, 504, 601, 602 are positioned so as to face each other or are positioned along a curved or angled tube.

At least one lens 502, 504, 601, 602 of the compression region 560 is associated to means for voltage supply for generating an electric field concentrating the particles in the stream 352 on the axis of the compression tube 501.

The compression region 560 comprises a first zone 500 (i.e. the compression zone) placed upstream (according to the flow direction of the stream 352) to at least one connection with the exhaust circuit 508 and a second zone 600 (i.e. the focusing zone) placed downstream to said at least one connection with the vapor exhaust circuit 508, thus the stream 352 entering in the second zone has less or is free of solvent vapor with respect to the stream entering or circulating in the first zone.

The first zone (compression zone) 500 comprises a sequence of at least two lenses 502 and 504 wherein the downstream lens 504 has an aperture with a smaller diameter in respect to the aperture of the upstream lens 502.

The second zone (focusing zone) 600 is connected to the vapor exhaust circuit only by passing through the first zone (compression zone) 500, while said first zone (compression zone) is directly connected with the vapor exhaust circuit 508. The second zone (focusing zone) 600 comprises a sequence of at least two lenses 601 and 602 wherein the downstream lens 602 has an aperture with a smaller diameter with respect to the aperture of the upstream lens 601.

The first zone 500 and the second zone 600 are separated from each other by a skimming aperture 506.

The second (focusing) region 600 comprises at least one lens 601, 602 provided with a passing aperture for reducing the cross-section of the stream 352 and for directing said stream without solvent onto a depositing surface 610. The second (focusing) region 600 may comprise only a single lens.

The depositing surface 610 is at ambient pressure and is placed in front of the compression region 560, preferably in front of the exit of said second zone 600 of the compression region 560.

The compression region 560 is fluidically connected with a circuit for sending a gas counter-flow 606 for the stream 352 of said mixture directed toward a target zone. More in detail, the gas flow 606 is directed in an opposite direction in respect to the stream 352 passing through the interface 350. In particular, said circuit for sending a gas counter-flow 606 for the stream 352 comprises means 608 for regulating the counter-flow, preferably a valve. Advantageously, said gas counterflow 606 is free of solvent vapor and can comprise gas at ambient pressure and/or ambient air and/or at least one inert gas, preferably at least one of the following gases: air, nitrogen, helium, argon. Preferably, said aperture for receiving a gas counter-flow 606 is fluidically connected with a regulated gas supply 612.

The compression region 560 is fluidically connected with a depositing surface 610 for receiving a gas counter-flow 606 for the stream 352, said gas counter-flow 606 is directed from the region containing said depositing surface 610 towards and within the compression region 560.

The compression region 560 is fluidically connected with the exhaust circuit 508 for receiving the solvent vapor component of the stream 352 and of the gas counter-flow 606. Preferably, the compression region 560 is fluidically connected with a radial vapor exhaust conduit 530 of the vapor exhaust circuit 508, in particular said vapor exhaust conduit is angled, preferably is perpendicular, to the stream 352 direction toward the target zone.

The exhaust circuit 508 of the compression region 560 is provided with flow regulating means 534 placed downstream in respect of corresponding first condensing means (condenser) 536. Preferably, the flow regulating means of the exhaust circuit 508 comprises a passage restrictor 534 toward a lower pressure region and/or comprises a positive displacement flow sink 532.

### Mass Flow Control in the Transport interface 350 (see FIG. 3)

The solution according to the invention comprises a first control mass flow that is positioned and acts upstream of the extraction barrier 402 and a second control mass flow that is positioned and acts downstream of the extraction barrier 402.

In particular, the first control mass flow comprises a flow control across the perforated extraction barrier 402 by means of the differential pressure created by the restriction 334 of solvent vapor exhaust 312 before the condensation 336 at essentially atmospheric pressure. By controlling the solvent vapor flow before the condensation 336, the flow of solvent vapor exiting from the cyclone chamber 322 and entering into the exhaust tube 312 is varied/controlled, thus varying/controlling the flow of remaining solvent with solutes directed toward the extraction barrier 402.

In particular, the second control mass flow comprises a counterflow rate 606 of dry gas by flow control 534 after the condensation 536 so as to regulate only the non-condensable dry gas flow independent of the condensable solvent vapor flow.

More in detail, the counterflow 606 of a non-condensable dry gas enters across the focusing zone 600 into the compression zone 500 wherein there is also the residual condensable solvent vapor of the stream 352 that has just crossed the perforated extraction barrier 402. Therefore, both the non-condensable dry gas of the counterflow 606 and the residual condensable solvent vapor flow can enter in the exhaust tube 530 of the compression region 560. By controlling the flow (for example by means of positive displacement pump 532 with flow restrictor 534 open, or using the flow restriction 534 with low pressure flow sink pump 532 after the condensation 536, only/mainly the counterflow 606 of non-condensable dry gas is varied/controlled since the residual condensable solvent vapor flow is condensed before to reach the flow control means 534 (this is advantageous since if the flow control were before condensation, both the counterflow of non-condensable dry gas and the residual condensable solvent vapor flow would be varied). Therefore, in this way, the counterflow 606 of non-condensable dry gas is varied/controlled independently of the condensable solvent vapor flow entering in the exhaust tube 530 of the exhaust circuit 508 in the compression region 560. By controlling the counterflow 606 aspirated in the exhaust tube 530 of the exhaust circuit 508, it is also controlled the gas counterflow 606 that enters and crosses in the focusing zone 600, thus varying/controlling the direct flow of solutes toward the deposition surface 610.

More in detail, a critical component of the mass transfer through the preferred embodiment detailed in FIG. 3 is accomplished by regulating the split ratio of enriched and solvent-depleted charged aerosol stream flowing across the extraction barrier 402 relative to the solute-depleted solvent vapor entering in the exhaust tube 312 of the vapor exhaust circuit 311. Exhaust tube 312 is insulated by thermal insulator 332 to ensure solvent vapor remains in the vapor phase. The split ratio controlling flow restriction 334 in the cyclone exhaust circuit 311 is prior to the solvent vapor condenser 336 and reservoir 338 to ensure that the flow is all in the gas phase. Residual aerosol stream carrying solvent vapor is removed downstream of the extraction barrier 402 and upstream of the focusing zone 600. This solvent vapor in the stream 352 crossing the perforated extraction barrier 402 and a controlled, solvent free, counterflow of gas 606 are removed from the compression region 560 through the compression exhaust circuit 508. In the compression exhaust circuit 508 flows the solvent vapor that is substantially condensed 536 and collected in reservoir 538 prior to the flow regulating means 534. This allows flow regulation of predominantly the non-condensable counter-flow gas 606 coming through the focusing zone 600. Advantageously, the flow regulating means of the compression exhaust circuit 508 can optionally be a restrictor 534 into a lower pressure region or can be into a positive displacement flow sink 532 such as a peristaltic, piston, or diaphragm pump. If a positive displacement pump, such as a micro gear pump capable of pumping liquid gas mixtures is used without the flow restrictor, the condensate can be pumped through the pump.

Solvent vapor is condensed on both exhaust circuits 311 and 508 and collected into corresponding reservoirs, respectively 338 and 538.

The solvent-depleted charged solute particles are electrostatically focused from the compression zone 500 through the focusing zone 600 to a sample collection surface 610 held at ambient pressure. The charged particles are further focused by virtue of the counter-current gas 606 flowing from the deposition region toward the compression region 560. The flow of counter current gas 606 is controlled by counter-current restrictor 608. Counter-current gas can be supplied by ambient gas or alternatively, by a regulated and metered gas supply 612. The counter-current gas 606 can be air, nitrogen, helium, argon, and/or other inert gases or gas mixtures. Mass transfer of charged solute particles from a dynamic aerosol source through the interface 350 are self-regulating by appropriate optimization of flow control and electrostatic voltage parameters.

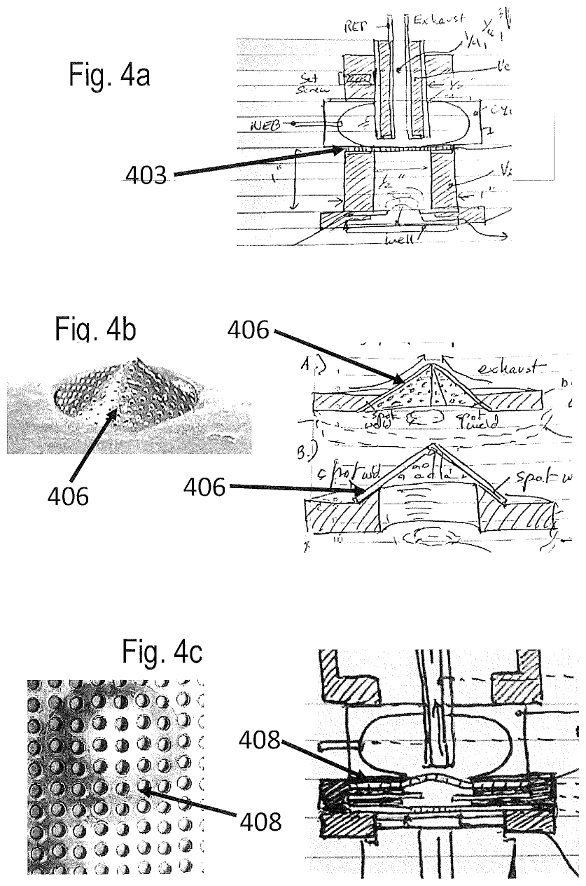

### Alternate Geometries of Extraction Barriers (see FIG. 4)

Extraction barriers are illustrated here to show alternatives for matching specific the barrier geometry and complexity to the aerosol properties, cyclone geometries, and the flow and composition of the sample stream 352 passing between the repeller 310 and the specific extraction barrier 402. Here we show a) planar 403, b) conical 406, and c) hemispherical 402 geometries. The geometry and openness of the barrier surface is an important component of the enrichment process for removing solvent-depleted solute particles from bulk solvent vapor flow. The circular motion of the aerosol in the cyclone region provides for tangential flow of deflected aerosol particles along the surface of the barrier 402 while minimizing the conductance of gas and maximizing the conductance of particles across the barrier.

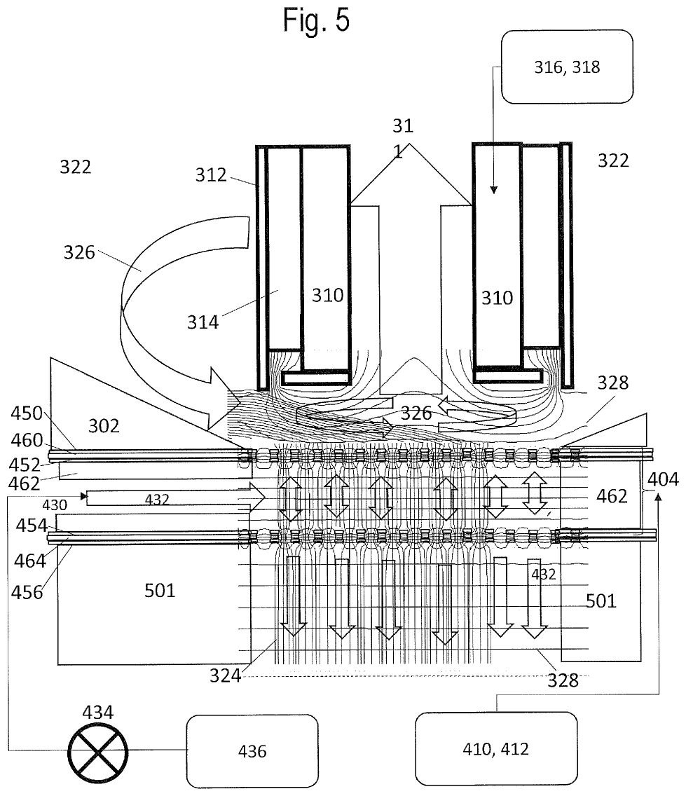

### Alternate Embodiments of Extraction Barrier (see FIG. 5)

In alternate extraction barrier embodiments, the aerosol particle enrichment surface includes more complex laminated elements and higher degrees of flow and field control than single layer barriers. FIG. 5 illustrates a laminated extraction barrier 402 comprising two dual layer perforated elements to achieve enhanced control over both control of flow of charged solvent-depleted particles and field applied said particles to move them across the barrier into downstream compression region. The first dual layer element comprises a first perforated surface 450 separated from the second perforated surface 452 by first insulator 460. A second dual layer element comprises a third perforated surface 454 separated from a fourth perforated surface 456 by second insulator 464. The two dual layer elements are further separated by third insulator 462 to provide sufficient space between the layers to introduce inert carrier gas through port 430. Inert carrier gas 432 is provided by supply 436. The laminated perforated extraction assembly 404 is placed opposite repeller 310 held at sufficient voltage to deflect the charged solute particles toward the barrier 404.

Introduction of inert carrier gas between the first layer and the second layer allows to more fully preventing solvent vapor from cyclone side of barrier from flowing into the compression region 500. Voltage differences between each layer in the laminates attracts the charged particles across each laminated barrier while preventing passage of solvent vapor, which is obstructed by addition of an inert (non-condensable) carrier gas 432.

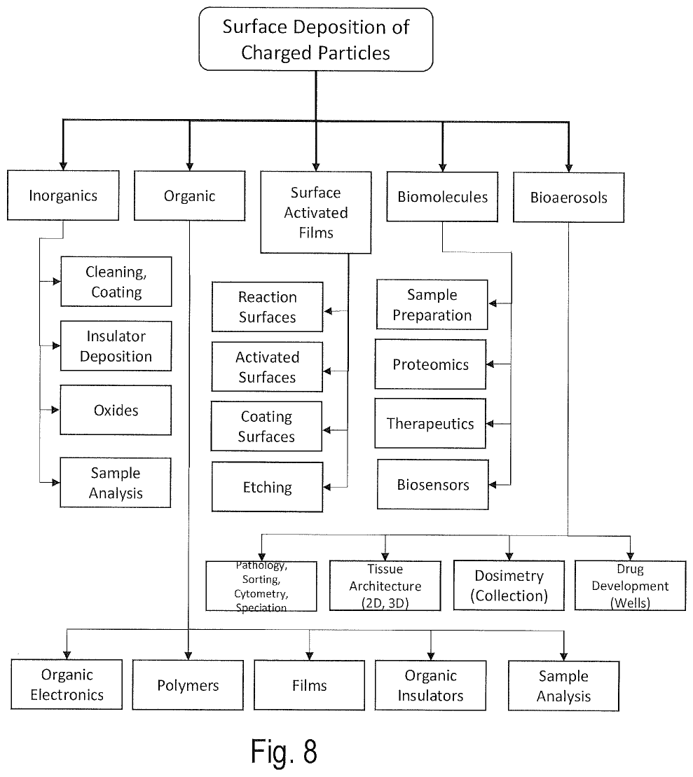

Advantageously, the addition of laminated barriers introduces greater temporal and quantitative control of transmission of solute particles to the downstream collection surface. For example, the combination of counter-flow of inert gas 432, coupled with instantaneous control of attractive or repulsive fields, can enhance solute delivery to the collection surface for improved precision of spatial and compositional properties of the said surface. This will have many benefits for broader deposition applications as described in FIG. 8 where solute deposition may be derived from multiple sources or multiple solutions.

### Compression and Transmission of Charged Solute Particles (see FIG. 6)

FIG. 6 illustrates simulated charged particle trajectories as they are deflected away from the repeller 310 and away from the circular bulk solvent flow 326. Equipotential lines 328 illustrate the contour of the potential surface that drives the charged particle away from the bulk flow, through the laminated barrier surfaces, and downstream through the compression zone 500 and focusing zone 600 for sample deposition.

The primary function of the compression region 560 is to convert a large cross-sectional flow of enriched solvent-depleted charged solute particles from the outlet of the perforated extraction barrier 402 into a small cross-section beam of particles that is more compatible with the spatial requirement for focusing said beam onto a micron sized spot on a collection disk. In addition, the compression region 560 serves to more fully deplete any residual background solvent vapor residing in the compression region further drying the solute particles. Here we illustrate several alternate embodiments for compression and focusing that can be configured for delivery to remote sample collection surfaces; namely, a) axial, b) uniform field extensions, and c) non-axial uniform field extensions. FIG. 6 are computer simulations of the motion of the motion of the dried solute particles traversing the compression zone 560 under the influence of both fluid dynamics and applies electric fields. Particles aligned at the entrance of the compression zone 560 are pushed down the tube by the flow from solvent vapor leaking across perforated barrier from the cyclone region into the compression region. The particle trajectories are representative of particles that are 10 nanometers in diameter (black) and 100 nanometers in diameter (green). A voltage applied to the compression lens 504 creates a focusing electric field that concentrates the particles on the axis of the compression tube 501. The compressed particle beam is skimmed through skimming aperture 506 and directed by influence of the electric fields emanating from focusing zone 600. The particle beam is focused to a sample spot 614 less than 100 um in diameter onto the sample collection surface 610.

FIGS. 6b and 6c illustrate embodiments that enable the focusing of the compressed beam to be displaced from the aerosol source region to accommodate spatial and positional requirements of the collection surface. For example, solute deposition spots may require alternate positions for laser optics for optical analysis conditions. These alternative embodiments provide examples for decoupling of adjacent processes within the present invention.

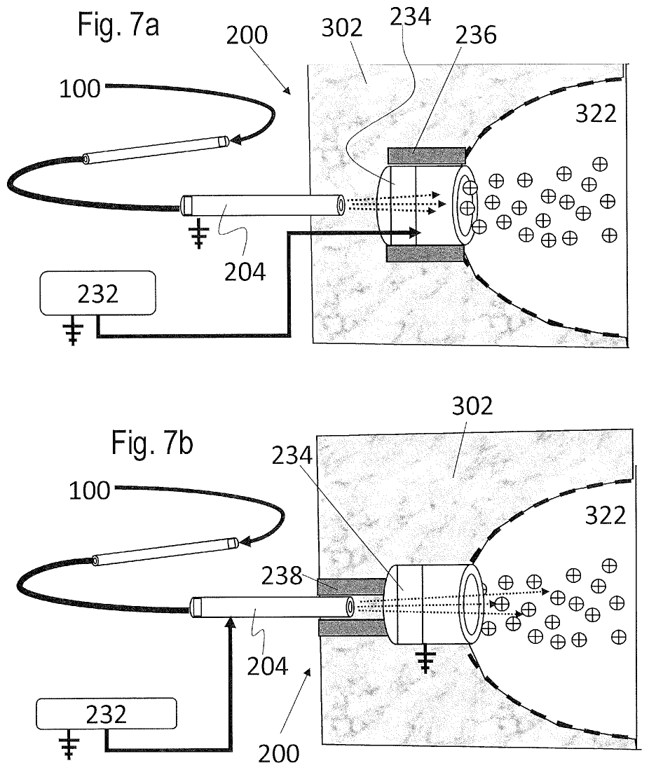

### Alternate Embodiments Using Induction Charging of Droplets (see FIG. 7)

Additional embodiments of the current invention utilize inductive charging of droplets emanating from the thermal nebulizer (sprayer) 204 by incorporate an induction electrode 234 on axis with the thermal vaporizer to provide alternative charging capabilities, including:
a) a grounded thermal nebulizer 204 with a floating induction electrode 234 (see FIG. 7a), or
b) a floating thermal nebulizer 204 with a grounded induction electrode 234 (see FIG. 7b).

The sample source 100 delivers the sample in a heated nebulizer 204 to generate a sonic and axially expanding aerosol delivered through an electric field of sufficient strength to induce electrons to leave either the induction electrode 234 toward the droplet spray or the droplets themselves toward the induction electrode 234. A voltage can be applied to either the nebulizer 204 or the induction electrode 234 by a voltage supply 232 to create sufficient electric field in the spray to strip electrons. The resulting polarity of the induced charge on the droplets is determined by the field produced by the applied voltage between the nebulizer 204 and the induction electrode 234. The two modes described herein, but not limited to, are by a grounded nebulizer 204 (see FIG. 7a) or by a grounded electrode 234 (see FIG. 7b), with voltage applied to the counter-element appropriately. The first insulating element 236 is required when configured as a grounded nebulizer (see FIG. 7a); conversely, the second insulating element 238 is required when configured for a grounded induction electrode (see FIG. 7b).

Induced charge upon the spray droplets provides enhanced control of both magnitude and polarity of charge on generated droplets. This control will provide the benefit of more uniform charging when sample is characterized by time-varying composition and solution properties.

### Applications of the Interface According the Invention (see FIG. 8)

Applications space of current invention for use for deposition of a wide variety of sample materials onto target surfaces for temporal, spatial, and compositional control of surface material. Although chemical analysis with LC-FTIR is a primary object of the invention, the invention has a broader range of applications for precise and quantitative delivery of material to any surface. This general diagram illustrates the utility of microscopic deposition of charged solute particles for applications in organic, inorganic, and biomolecular material deposition, these would include 2D and 3D printing at the molecular level. Control of all material deposited with respect to composition, physical space, and time creates a tool for complex engineering of multi-dimensional surfaces such as 3D circuits or tissue engineering. The interface according to the invention is in a broader sense, a tool/device for creating surface composition of any orientation of materials. It is also a tool for recording materials from liquid sources beyond our preferred chromatographic source to sources for time monitoring any variety of liquid streams for subsequent analysis and diagnostics.

In general, the present invention relates to a transport interface configured to reduce, preferably to remove, the liquid or solvent component in a solution or suspension mixture provided as input. Preferably, the input can comprise any mixture in the form of:
a solution of at least one solvent component with at least one solute component, or
a suspension of at least one solid component with at least one liquid component and/or at least one gas/vapor component.

Therefore, the interface of the present invention can be used in all applications wherein there is a need to have an output with a reduced or removed liquid/solvent component in respect to the mixture at the input.

Moreover, the interface is suitable to be used in all applications wherein there is the need to have a controlled transportation of the input mixture flow toward the output.

The interface is configured to deliver the output (having a reduced or removed liquid/solvent component in respect to the input mixture) toward or on a specific target, preferably but not necessarily a deposition surface. Moreover, the flow at the output of the interface, that is delivered toward or on a target, for example a specific location, is more focused than at the input, i.e. has a reduced cross-section.

Moreover, the interface is suitable to be used in all applications wherein there is the need to have at the same time:
the reduction or removal of the liquid/solvent component of the input mixture,
the time and/or quantity control of the output flow,
a more focused/concentrated output flow.

The interface according to the present invention can also be considered as a conditioning device of a sample provided as input.

Reference Numbers in Drawings

| Part Name | Number |
|---|---|
| Liquid Sample Introduction Means | 100 |
| Aerosol Generation Means | 200 |
| Heated Nebulizer | 204 |
| Induction Voltage Supply | 232 |
| Inductive Charging Electrode | 234 |
| Charging Electrode Insulator | 236 |
| Nebulizer Insulator | 238 |
| Desolvation and/or Evaporation Means | 300 |
| Cyclone Block | 302 |
| Cyclone Heaters | 304 |
| Interface Entry region | 309 |
| Repeller | 310 |
| Cyclone/Further Exhaust Vapor Circuit | 311 |
| Cyclone Exhaust Vapor Tube | 312 |
| Cyclone Repeller Insulator | 314 |
| Cyclone Repeller Voltage Supply | 316 |
| Cyclone Repeller Current Measurement Means | 318 |
| Cyclone Current Measurement Means | 320 |
| Cyclone Chamber | 322 |
| Solvent-Depleted Charged Solute Particle Trajectories | 324 |
| Cyclone Aerosol Motion | 326 |
| Equipotential Lines | 328 |
| Exhaust Tube Thermal Insulation | 332 |
| Exhaust Tube Restrictor | 334 |
| Condenser of Further Exhaust Vapor Circuit | 336 |
| Cyclone Reservoir Exhaust | 338 |
| Reservoir Exhaust of Further Exhaust Vapor Circuit | 340 |
| Transport Interface | 350 |
| Stream of the mixture through the interface | 352 |
| Extraction and Enrichment Zone | 400 |
| Perforated Extraction Barrier | 402 |
| Planar Perforated Extraction Assembly | 403 |
| Dual Laminated Perforated Extraction Barrier | 404 |
| Conical Perforated Extraction Barrier | 406 |
| Hemispherical Perforated Extraction Barrier | 408 |
| Dual Laminated Perforated Extraction Voltage Supply | 410 |
| Perforated Extraction Current Measurement Means | 412 |
| Inert Carrier Gas Port | 430 |
| Inert Carrier Gas Motion | 432 |
| Inert Carrier Gas Restriction | 434 |
| Inert Carrier Gas Supply | 436 |
| First Perforated Surface | 450 |
| Second Perforated Surface | 452 |
| Third Perforated Surface | 454 |
| Forth Perforated Surface | 456 |
| First Insulator layer | 460 |
| Second Insulator layer | 462 |
| Third Insulator layer | 464 |
| Compression zone | 500 |
| Charged Solute Particle Compression Tube | 501 |
| Compression Lens 1 | 502 |
| Compression Lens 2 | 504 |
| Compressed Charged Particle Skimming Aperture | 506 |
| Compression Exhaust Circuit | 508 |
| Linear Uniform-Field Extension Tube | 510 |
| Curved Uniform-Field Extension Tube | 512 |
| Compression Exhaust Tube | 530 |
| Compression Exhaust Pump | 532 |
| Compression Exhaust Restrictor | 534 |
| Compression Exhaust Condenser | 536 |
| Compression Exhaust Reservoir | 538 |
| Compression Pump Exhaust | 540 |
| Compression region | 560 |
| Focusing and Deposition zone | 600 |
| First Focusing Lens | 601 |
| Second Focusing Lens | 602 |
| Counter-Current Gas Flow | 606 |
| Counter-Current Gas Restrictor | 608 |
| Deposition surface | 610 |
| Counter-Current Gas Control and Meter | 612 |
| Sample Spot | 614 |
| Sample Detection and Analysis Means | 700 |

1. An interface (350) for the controlled transport of a flow of an inlet mixture (352), in solution or suspension, towards a target zone, towards a deposition surface (610), the interface comprising:
a perforated extraction barrier (402) comprising at least one laminar element perforated with a plurality of holes intended to be crossed by a flow of said mixture (352), said perforated extraction barrier (402) being positioned at the entrance of a compression region (560) configured to reduce a cross section of said flow (352),
said compression region (560) being fluidically connected with at least one opening for the inlet of a gas counterflow (606),
said compression region (560) being fluidically connected with an exhaust circuit (508) for at least one gas, said exhaust circuit (508) being positioned between the perforated extraction barrier (402) and the opening for the inlet of said gas counterflow (606).

2. The interface according to claim 1, wherein the compression region (560) comprises at least one lens (502, 504, 601, 602) for electro-optical compression of the cross section of the flow (352) passing therethrough.

3. (canceled)

4. The interface according to claim 1, wherein a pressure differential is defined/created across the perforated extraction barrier (602).

5. (canceled)

6. The interface according to claim 1, wherein said gas counterflow (606) comprises at least one inert gas.

7. (canceled)

8. The interface according to claim 1, wherein said gas counterflow (606) is controlled.

9. The interface according to claim 1, wherein said exhaust circuit (508) of the compression region (560) comprises a flow control (534) which is positioned downstream with respect to condensation means (536).

10. The interface according to claim 1, further comprising an inlet region (309) which is positioned upstream of the compression region (560) and is separated from the latter by the perforated extraction barrier (402), said inlet region (309) being fluidically connected with a further exhaust circuit (311) for at least one gas, said further exhaust circuit (311) comprising a further flow control (334) which is positioned upstream of further condensation media (336).

11. An interface (350) for the controlled transport of a flow of an inlet mixture (352), in solution or suspension, towards a target zone, towards a deposition surface (610), wherein said interface comprises:
a perforated extraction barrier (402) comprising at least one laminar element perforated with a plurality of holes intended to be crossed by a flow of said mixture (352), said perforated extraction barrier (402) being positioned at the entrance of a compression region (560) configured to reduce the cross section of said flow (352),
said compression region (560) being fluidically connected with at least one opening for the inlet of a gas counterflow (606),
said compression region (560) being fluidically connected with an exhaust circuit (508) for at least one gas, said exhaust circuit (508) being positioned between the perforated extraction barrier (402) and the opening for the inlet of said gas counterflow (606), and wherein the interface comprises an exit/deposit region which:
comprises said target zone which is defined by a deposition surface (610),
is positioned downstream of the compression region (560), and
is fluidically connected with said opening for the inlet of said gas counterflow (606).

12. The interface according to claim 10, further comprising, at the inlet region (309) which is positioned upstream of the compression region (560) and of the perforated extraction barrier (402), deflection means (310) configured to remove the solute particles present in the flow of said mixture (352) from the inlet of said further exhaust circuit (311) and to divert the particles of said flow towards said perforated extraction barrier (402).

13. The interface according to claim 12, wherein said deflection means comprise at least one repeller electrode (310) configured to generate an electric field which is orthogonal to the flow of the mixture (352).

14. The interface according to claim 13, wherein said at least one repeller electrode (310), the inlet of said further exhaust circuit (311) and the perforated extraction barrier (402) face each other.

15. The interface according to claim 1, wherein said compression region (560) comprises:
a first zone (500) which is placed upstream with respect to at least one connection with the discharge circuit (508),
a second zone (600) which is located downstream with respect to said at least one connection with the exhaust circuit (508), therefore the flow entering the second zone (600) has less or is free of solvent vapors with respect to the flow entering or circulating in the first zone (500).

16. The interface according to claim 1, wherein the interface is configured so that said mixture to be transported is a nebulized and evaporated liquid chromatographic effluent.

17. The interface according to claim 1, wherein the interface is configured so that said mixture to be transported contains electrically charged droplets with at least one solute component carried by a vapor of said solvent.

18. The interface according to claim 1, wherein the compression region (560) is fluidically connected with a radial vapor exhaust conduit (530) of the vapor exhaust circuit (508), said vapor exhaust conduit being perpendicular, to the stream direction toward the target zone.

19. The interface according to claim 1, further comprising a deposition surface (610) that is placed at the exit of the compression region (560) and that is at ambient temperature.

20. The interface according to claim 19, wherein said deposition surface (610) is movable and comprises a surface that is suitable for chemical analysis.

21. The interface according to claim 1, wherein the perforated extraction barrier (602) comprises at least two perforated laminar elements, with a plurality of holes, overlapping and spaced apart from each other.

22. The interface according to claim 1, wherein the compression region (560) comprises a tapered portion that is defined above a single electro-optical compression lens (504) configured for providing the electrostatic focusing directly onto the deposition surface (610).

23. An apparatus for coupling a liquid chromatography device to an analyzer, of the IR spectroscopy type, the apparatus comprising:
means (200) for generating an aerosol from a liquid stream leaving the liquid chromatography device, said aerosol comprising a solvent component and, intermittently, at least one electrically charged solute component,
means (300) for desolvating said solute component and evaporating said aerosol,
an interface (350) according to one or more of the preceding claims, which is positioned at the outlet of said means (300) for desolvating said solute component and evaporating said aerosol, said interface receiving at its input a solution mixture containing at least one vapor component of said solvent and at least one solute component, so as to deliver said at least one solute component in a more concentrated and solvent-depleted way toward the target zone, on a deposition surface (610).
